(19) United States
(12) Patent Application Publication
(10) Pub. No.: US 2003/0094420 A1
(43) Pub. Date: May 22, 2003

(54) On-line electrochemical fe (VI) water purification

(76) Inventor: Stuart Licht, Technion City (IL)

Correspondence Address: BROWDY AND NEIMARK, P.L.L.C., 624 NINTH STREET, NW, SUITE 300, WASHINGTON, DC, 20001-5303, US

(21) Appl. No.: 10/201,643

(22) Filed: Jul. 24, 2002

(30) Foreign Application Priority Data
Jul. 24, 2001 (IL) 144536

(51) Int. Cl. B03C 1/00

(52) U.S. Cl. 210/748

(57) ABSTRACT

The invention provides an on-line electrochemical Fe(VI) water purification. Fe(VI) is an unusual and strongly oxidizing form of iron, which can be used as a less hazardous water purifying agent than chlorine. Solid Fe(VI) salts require costly syntheses and stabilization steps, and solutions of Fe(VI) are unstable. The claimed on-line electrochemical Fe(VI) water purification avoids these limitations. Fe(VI) is directly and rapidly prepared in solution as the FeO₄²⁻ ion and is immediately available to breakdown a wide range of water contaminants including, but not limited to, sulfides and other sulfur containing compounds, cyanides, ammonia and other nitrogen containing compounds, organics and viruses.

The present invention relates to an improvement to water purification methods which is less hazardous simpler, and cost effective compared to existing methods. More particularly, the invention relates to a novel on-line electrochemical Fe(VI) water purification invention in which Fe(VI) is directly and rapidly prepared in solution as the FeO₄²⁻ ion and is available to breakdown a wide range of water contaminants.

### BACKGROUND OF THE INVENTION

Fe(VI) is an unusual and strongly oxidizing form of iron, which can be used as a less hazardous water purifying agent than chlorine. V. K. Sharma et al. have demonstrated using the Fe(VI) salt, K₂FeO₄, the removal from water of ammonia, cyanide, and sulfide (J. Env. Sci. & Health, A, 1998, 33, 635; Environ. Sci. Technol. 1998, 32, 2608; Environ. Sci. Technol. 1997, 31, 2486). S. J. Luca et al. also used K₂FeO₄ to remove these compounds and organic compounds and to generally diminish the offensive odor of these compounds in water (Wat. Sci. Tech., 1996, 33, 119). F. Kazama has demonstrated viral inactivation by K₂FeO₄ (Wat. Sci. Tech., 1995, 31, 165). J. P. Deininger et al. have used an alkaline earth ferrate salt to remove transuranic elements from water in U.S. Pat. No., 4,983,306 (Jan. 8, 1991). In each of these processes, the alkali or alkaline earth ferrate salt is added to prepare a solution of Fe(VI) ions, which is the used as the water treatment agent.

Two limitations are posed to the implementation of Fe(VI) water purification. The Fe(VI) solid salts require costly syntheses and stabilization steps, and secondly, prepared solutions of Fe(VI) are unstable. J. P. Deininger has claimed methods for the electrochemical formation of potassium, sodium, and calcium/sodium ferrate adduct, which require a recovery step of said ferrate in U.S. Pat. No., 4,435,257, Mar. 6, 1984; U.S. Pat. No., 4,451,338, May 29, 1984; U.S. Pat. No., 4,435,256, Mar. 6, 1984. The preparation of Fe(VI) salts by chemical means has also been accomplished, and in a multi step procedure, generally includes a hypochlorite oxidation step of Fe(III) salts as described by G. Thompson (J. Amer. Chem. Soc. 73, 1379, 1951), or by precipitation from another Fe(VI) salt, such as reported by J. Gump et al. (Anal. Chem. 26, 1957, 1954).

Fe(VI) solutions are known to be highly unstable. Decomposition with reduction of the iron to a less oxidized form (i.e. to a lower valence state) occurs very rapidly, the stability of Fe(VI) salt solutions being only the order of a few hours at room temperature (Anal. Chem. 23, 1312-4, 1951). The instability maybe retarded, but not stopped at low temperatures, or with careful control of solution concentrations as described by S. Licht et al. (Science, 1999, 285, 1039). Therefor without steps to refrigerate or highly purify the solution, the solutions can not be stored even temporarily, posing a severe limitation to water purification.

The claimed on-line electrochemical Fe(VI) water purification avoids these limitations. It is an object of the present invention to provide an improvement to water purification methods which is less hazardous simpler, and cost effective compared to existing methods. Fe(VI) is directly and rapidly prepared in solution as the FeO₄²⁻ ion and is immediately available at high purity to breakdown a wide range of water contaminants including, but not limited to, sulfides and other sulfur containing compounds, cyanides, ammonia and other nitrogen containing compounds, organics and viruses.

### BRIEF DESCRIPTION OF THE INVENTION

The invention provides an on-line electrochemical Fe(VI) water purification. Fe(VI) is an unusual and strongly oxidizing form of iron, which can be used as a less hazardous water purifying agent than chlorine. Solid Fe(VI) salts require costly syntheses and stabilization steps, and solutions of Fe(VI) are unstable. The claimed on-line electrochemical Fe(VI) water purification avoids these limitations. Fe(VI) is directly and rapidly prepared in solution as the FeO₄²⁻ ion and is available to breakdown a wide range of water contaminants including, but not limited to, sulfides and other sulfur containing compounds, cyanides, ammonia and other nitrogen containing compounds, organics and viruses.

### BRIEF DESCRIPTION OF THE FIGURES

FIG. 1 is a diagrammatic illustration of the on-line electrochemical Fe(VI) water purification according to the invention.

FIG. 2 illustrates graphically analysis aspects of the invention as described in the Examples.

### DETAILED DESCRIPTION OF THE INVENTION

The novel water purification devices according to the present invention is based on the on-line electrochemical formation and addition of Fe(VI), in the form of the FeO₄²⁻ ion, to the water to be purified.

Electrochemical formation of the FeO₄²⁻ ion is accomplished by the oxidation, by positive electrical bias, of an iron containing anode in contact with an electrically neutral ionic conductor, such as an aqueous solution. The positive electrical bias is accomplished by a power supply contacting a second electrode, a cathode, also in the solution. In one embodiment, the iron containing anode consist of metallic iron, and in a preferred embodiment consists of a high surface area iron including, but not limited to, iron wire, iron screen, or a porous iron. In another embodiment, the iron containing anode may contain an iron salt, including, but not limited to, Fe₂O₃, Fe(OH)₂, or all ferrous and ferric salts. In one embodiment, the water to be purified is in contact and flows passed the anode. In a preferred embodiment, the water to be purified, and the FeO₄²⁻ electrochemically formed in solution at the anode, each have a separate flow which are brought together as a single flow downstream of the anode. In one embodiment these flows are brought together by means of a gravity feed. In another, embodiment they are brought together by a mechanical mixer. In a preferred embodiment they are brought together by means of a pump.

In one embodiment the surface of the cathode which is exposed to the solution is comprised of a material that does not decompose when immersed under negative electrical bias in solution. In a preferred embodiment, this cathode contains nickel and nickel oxide, and in other embodiments may contain, but not be limited to, platinum, gold, graphite, carbon black, iridium oxide or ruthenium oxide.

According to another embodiment of the invention, means are provided to impede transfer of chemically reactive species between the anode and the cathode. In one embodiment said means comprises situating the anode downstream of the cathode. In an another embodiment said means comprises a non conductive separator configured with open channels, grids or pores, a ceramic frit, or agar solution. In a preferred embodiment said means comprises a membrane to impede FeO₄²⁻ transfer, including but not limited to a cation selective membrane, between the anode and the cathode.

The electrically neutral ionic conductor utilized in the present invention, comprises a medium that can support FeO₄²⁻ ion formation density during oxidation of the iron containing anode. A typical representative ionic conductor is an aqueous solution preferably containing a high concentration of a hydroxide such as NaOH or simply the water to be treated. In other typical embodiments, the electrically neutral ionic conductor comprises a high concentration of NaOH.

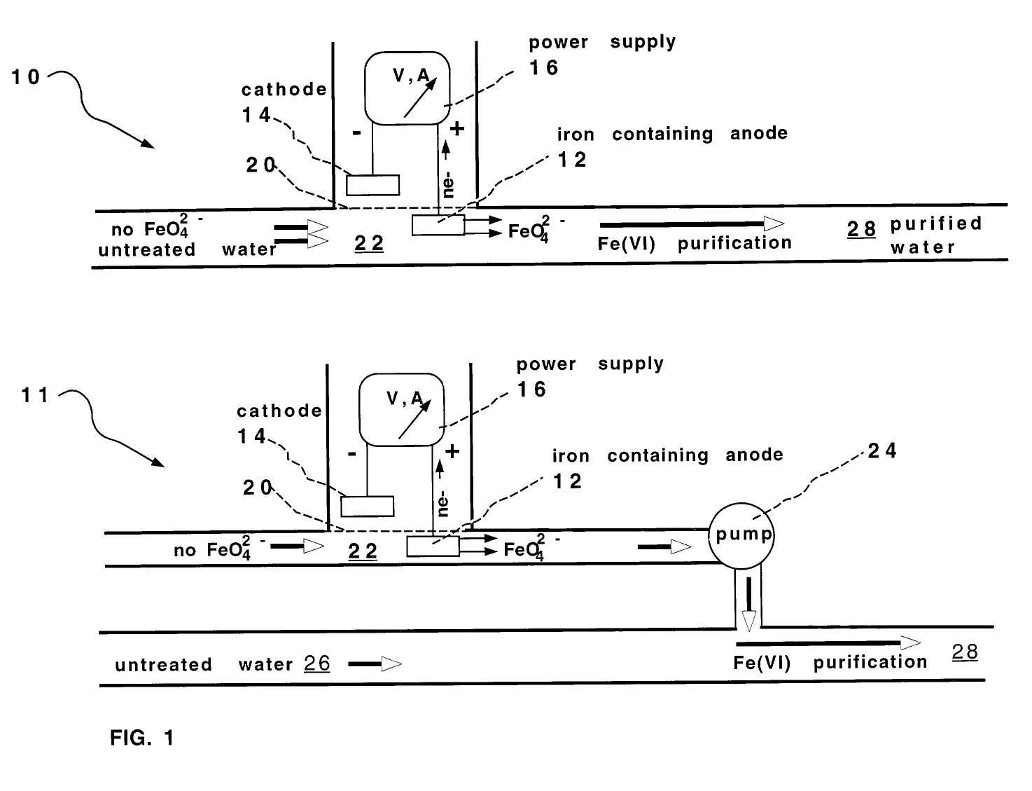

### DETAILED DESCRIPTION OF FIG. 1

FIG. 1 illustrates schematically a device for water purification 10 or 11 based on an iron containing anode half cell, an electrically neutral ionic conductor and a cathode. The cell 10 contains an electrically neutral ionic conductor 22, such as the impure water to be treated, in contact with the anode 12. Oxidation of the anode, is achieved via electrons driven out by an electrical bias supplied by power supply 16 into the cathode 14. Optionally, the cell may contain a separator 20, for minimizing the non-electrochemical interaction between the cathode and the anode. The cathode electrode 14, such as in the form of conductive carbon is also in contact with the electrically neutral ionic conductor 22. FeO₄²⁻ ions are formed by the oxidation of the anode and are released into the neutral ionic conductor. Action of the FeO₄²⁻ on water impurities forms Fe(VI) purified water 28. Optionally, as illustrated in the cell 11, the FeO₄²⁻ ions released into the neutral ionic conductor, may be flow into, as for example directed by pump 24, into the water to be treated 26.

The invention will be hereafter illustrated in further detail with reference to the following non-limiting examples, it being understood that the Examples are presented only for a better understanding of the invention without implying any limitation thereof, the invention being covered by the claims. It will be understood by those who practice the invention and by those skilled in the art, that various modifications and improvements may be made to the invention without departing from the spirit of the disclosed concept.

### EXAMPLE 1

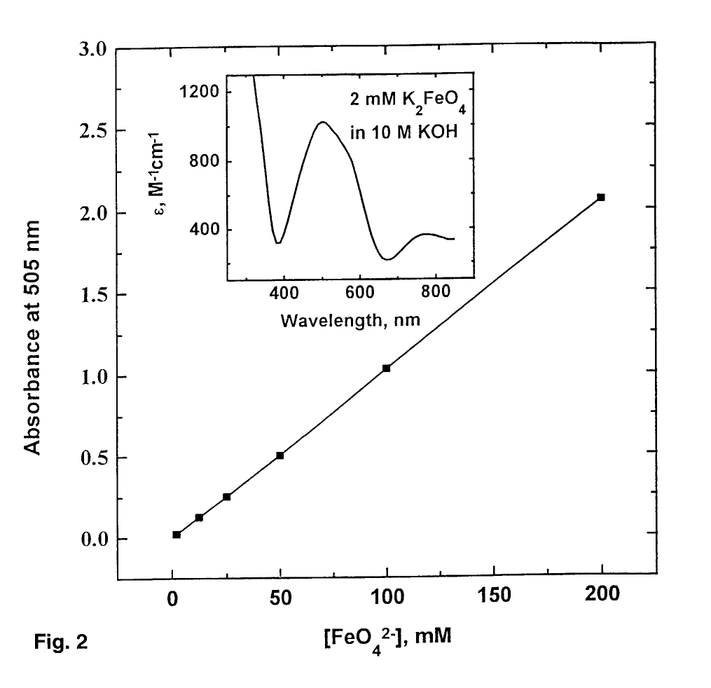

This example shows that Fe(VI) may be readily formed on-line in an aqueous solution as the ion FeO₄²⁻. The established visible absorption spectra is shown in the inset of FIG. 2. The absorption of FeO₄²⁻ at 505 nm varies linearly with the concentration of in FeO₄²⁻ solution, and as shown in the main portion of FIG. 2, the measurements show that this variation is highly invariant using a wide variety of FeO₄²⁻ concentrations. Furthermore, we find the absorption magnitude of FeO₄²⁻ is the same with aqueous alkaline solutions composed of LiOH, NaOH, KOH, RbOH and CsOH of a wide variety of concentrations. This 505 nm absorption provides a useful measure of the quantity of Fe(VI) formed in solution. The anode may consisted of an iron sheet, but a higher surface area iron anode, such as a folded iron wire,, increases the rate Fe(VI) formed in solution. The Fe(VI) formation solution may consist of a less concentrated hydroxide solution, but a more concentrated alkaline solution, such as saturated NaOH, increases the rate Fe(VI) formed in solution.

Table 1 summarizes the rate of Fe(VI) buildup for a variety of aqueous solutions and operating conditions. In the Fe(VI) formation experiments, summarized in Table 1, a 50 cm² iron sheet or a 800 cm² iron anode, prepared by folding 128 meters of 200 micrometer diameter iron wire, is placed as an anode in 30 milliliter of various aqueous solutions. A cathode, consisting of a 50 cm² sheet of nickel, is also placed in the solution and prevented from direct contact with the iron wire by means of an open PVC screen or a R1010 cation selective membrane. The positive bias of a power supply is connected to the anode and the negative bias to the cathode. The power supply controls a constant current, such as 1.6 amperes, between the anode and cathode, and the measured FeO₄²⁻ buildup in time is measured by the 505 nm absorption to determine the quantity of Fe(VI) formed in solution. As summarized in Table 1, the FeO₄²⁻ buildup is more rapid with the additional use of a cation selective membrane, separating the anode and cathode in the cell. The rate of this Fe(VI) buildup is also more rapid at higher applied current, and higher hydroxide concentration, and rates of several millimolar Fe(VI) generated per minute are sustainable. Without being bound to any theory, the charge efficiency for Fe(VI) production can be estimated by comparing the equivalents of charge consumed (product of constant current with time) to the measured equivalents of hexavalent iron generated. As seen in Table 1, whereas the Fe(VI) buildup is highest at high absolute currents, the charge efficiency is highest for intermediate current densities.

TABLE 1
The rate of Fe(VI) buildup in 30 ml of solution for a variety of
aqueous solutions and operating conditions, and with, or without a
cation selective separator. I = applied current, J = applied current density.

| | | | | | | mM Fe(VI) buildup | |
|---|---|---|---|---|---|---|---|
| Fe anode | | | | I | J | charge | [FeO₄²⁻] |
| type | area cm² | separator | solution | mA | mA/cm² | efficiency | per h |
| sheet | 50 | with | 18 M NaOH | 1600 | 32 | 27% | 90 mM |
| wire | 800 | with | 18 M NaOH | 1600 | 2 | 54% | 180 mM |
| wire | 800 | with | 18 M NaOH | 400 | 0.5 | 72% | 60 mM |
| wire | 800 | without | 18 M NaOH | 400 | 0.5 | 18% | 15 mM |
| wire | 800 | with | 18 M NaOH | 100 | 0.125 | 63% | 13 mM |
| wire | 800 | with | 5 M NaOH | 1600 | 2 | 3.3% | 11 mM |
| wire | 800 | with | 5 M KOH | 1600 | 2 | 2.9% | 9 mM |
| wire | 800 | with | 5 M LiOH | 1600 | 2 | 3.1% | 10 mM |
| wire | 800 | with | 1 M NaOH | 1600 | 2 | 0.5% | 1.8 mM |

### EXAMPLE 2

This example shows that on-line formed Fe(VI) will purify water. In this example a specific water impurity, sulfide, as can be found in concentrated hydroxide solutions in the preparation of pulp for the paper industry, is removed by on-line treatment with Fe(VI). A representative contaminated solution is prepared with a 10 millimolar sulfide solution by dissolution of 10 mM Na₂S in 5 M NaOH. The sulfide concentration is potentiometrically analyzed by a commercial (Orion Co.) silver sulfide ion selective electrode, and the untreated, sulfide solution exhibits an unchanging sulfide concentration of 10 mM in time. 30 ml of this representative contaminated solution is placed in the anode compartment of the on-line Fe(VI) generator, as described in Example 1. The Fe(VI) generation is initiated by application of a 1.6 amperes anodic current to the 800 cm² iron electrode, and the ion selective electrode used to measure the variation of the sulfide concentration in time. As seen in Table 2, the formed Fe(VI) produces a rapid and complete removal of the sulfide impurity.

TABLE 2
The breakdown of a sulfide contaminant by on-line generated
Fe(VI) as measured by the decrease in time from the initial constant
concentration of sulfide.

| Time following initiation | Measured sulfide concentration |
|---|---|
| of constant 1.6 A current | during on-line Fe(VI) generation |
| to Fe(VI) generator | C° = initial [Na₂S] = 10 mM sulfide |
| 0 minutes | 10 mM sulfide |
| 10 minutes | 7 mM sulfide |
| 20 minutes | 5 mM sulfide |
| 30 minutes | 2 mM sulfide |
| 40 minutes | 0 mM sulfide |

1. A water purification device comprising two half-cells which are in an electrochemical contact with one another through a neutral ionic conductor consisting of an aqueous solution, and are in external electrical contact through an electrical bias generating power supply, wherein one of said half-cells comprises an iron containing anode and the other half-cell comprises a cathode. Whereby into the aqueous solution, FeO₄²⁻ ion is formed on-line via oxidation of the positively biased anode and reduction by the negatively biased cathode, and the formed FeO₄²⁻ in solution comes in contact with the water to be purified.

2. The water purification device according to claim 1 whereby said water to be purified flows through said anode half cell.

3. The water purification device according to claim 1 whereby said water to be purified and said FeO₄²⁻ in solution each have a separate flow which are brought together as a single flow downstream of said anode.

4. The water purification device according to claims 2 or 3 further comprising means to impede transfer of chemically reactive species between said anode and said other half cell.

5. The water purification device according to claim 4 wherein said means comprises situating said anode downstream of said cathode.

6. The water purification device according to claim 4, wherein said means is a non conductive separator configured with open channels, grids or pores, a ceramic frit, or agar solution.

7. The water purification device according to claim 4 wherein said means to impede chemically reactive ion transfer comprises a membrane positioned to separate said half cells.

8. The water purification device according to claim 7 wherein said ion is FeO₄²⁻.

9. The water purification device according to claim 3 wherein said separate flow are brought together by means of a pump.

10. The water purification device according to claim 3 wherein said separate flow are brought together by means of a gravity feed.

11. The water purification device according to claim 3 wherein said separate flow are brought together by means of a mechanical mixer.

12. The water purification device according to claim 1 wherein said cathode is does not decompose, and sustains electrochemical reduction of said aqueous solution.

13. The water purification device according to claim 12 wherein said cathode has a surface exposed to solution containing nickel, and/or nickel oxide.

14. The water purification device according to claim 12 wherein said cathode has a surface exposed to solution containing platinum, gold, graphite, carbon black, iridium oxide or ruthenium oxide.

15. The water purification device according to claim 1 wherein said iron containing anode contains metallic iron.

16. The water purification device according to claim 14 wherein said metallic iron is of high surface area.

17. The water purification device according to claim 14 wherein said high surface area iron is in the form of iron wire, iron screen, or a porous iron.

18. The water purification device according to claim 1 wherein said iron containing anode contains an iron salt.

19. The water purification device according to claim 17 wherein said iron salt is a ferric salt.

20. The water purification device according to claim 17 wherein said iron salt is a ferrous salt.
